(19) United States
(12) Patent Application Publication
(10) Pub. No.: US 2021/0148471 A1
(43) Pub. Date: May 20, 2021

(54) DURABLE AND LOW MAINTENANCE VALVE

(71) Applicant: Caterpillar Inc., Peoria, IL (US)

(72) Inventors: Vickram Murugesan, McHenry, IL (US); Robert Eugene Riedel, JR., Fox River Grove, IL (US)

(73) Assignee: Caterpillar Inc., Peoria, IL (US)

(21) Appl. No.: 16/688,397

(22) Filed: Nov. 19, 2019

(51) Int. Cl. F16K 5/04; B23P 15/00

(52) U.S. Cl. CPC F16K 5/045; B23P 15/001

(57) ABSTRACT

A plug valve is disclosed having one or more components that are coated to reduce wear on the components. A plug of the valve may include a bore therethrough defined by an inner surface of the plug. The inner surface of the plug may include a nitride layer, such as a carbonitride layer. An outer surface of the plug may include both a nitride layer, in addition to a thermal spray coated layer, such as WC. The nitride layer may be formed by a ferritic nitrocarburizing process and the thermal spray coating may be formed by a high velocity air fuel (HVAF) or similar process. Inserts of the plug valve may also be coated by similar processes. An outer surface of the inserts may have a nitride layer and an inner surface of the inserts may have a nitride layer and a thermal spray coating.

### TECHNICAL FIELD

The present disclosure relates to durable and low maintenance valves. More specifically, the present disclosure relates to valves and/or valve parts that have been treated to improve their durability, as well as reduce needed maintenance during their use.

### BACKGROUND

Various types of valves are in widespread use in a variety of industries. For example, plug valves may be used in the oil and gas extraction industry. In such examples, slurry may be injected through a plug valve for hydraulic fracturing (fracking) based extraction of hydrocarbon resources. In these types of applications, the slurry, having hard proppant particles therein, may be under high pressures, such as 15,000 pounds per square inch (psi). As slurry is forced through valves that allow, block, and/or throttle their flow, the surfaces of the valves and/or the constituent valve parts may be subject to high levels of wear and/or corrosion due to the highly pressurized slurry. Excessive wear of the of the valve and/or valve parts can lead to reduced lifetimes of the valve. Increased frequency of maintenance and/or reduced lifetime of the valves can result in reduced levels of uptime of processes reliant on the valves. For example, in fracking applications, maintenance can temporarily stop the production of hydrocarbons and/or hydraulic drilling from a fracking site.

In plug valves, certain components may be subject to excessive levels of wear in high pressure environments, such as in applications where pressurized slurry is fed through the plug valve. For example, a plug of the plug valve may be subject to excessive wear during operation of the plug valve. Inserts of the plug valve that line the plug within a body of the plug valve may also be subject to high levels of wear. These components may require attention for preventive maintenance during use of the plug valve. For example, various components of plug valves may need to be greased periodically. Additionally, these components may need to be replaced when they wear out. Preventive maintenance and/or servicing to replace components may result in production downtime and/or costs for the activities (e.g., hydrocarbon fracking) enabled by the plug valve.

In an effort to improve the wear lifetime and/or the flow resistance within the plug valve, components of the plug valve may be coated with materials that resist wear. However, such processes may not provide a sufficient thickness of wear resistance materials and the processes for depositing the wear resistance materials may be inherently slow and/or costly. Additionally, in some high pressure and/or high wear applications, portions of the plug valve may be coated with grease or other materials to improve the ease of actuation of the valve. Applying such coatings may result in further downtime and may further increase costs.

As an example of producing plug valves, U.S. Pat. Pub. No. 10,203,037 (hereinafter '037 publication) describes a method for providing coatings and surface finishes on valve plugs and sleeves. However, the method of the '037 publication may not be cost effective and may not provide a coating on all areas of critical components and/or regions of high wear. Additionally, the '037 publication does not discuss providing more than one kind of coating and further does not discuss coating a bore of a plug of a plug valve.

Example embodiments of the present disclosure are directed toward overcoming the deficiencies described above.

### SUMMARY

In an example embodiment of the present disclosure, a method for manufacturing a valve component may include ferritic nitrocarburizing a rough valve component to form a nitride layer over a surface of the valve component. The ferritic nitrocarburizing includes a molten salt bath nitridation. The rough valve component may be formed from ferrous material having a substantially ferritic crystal structure. The method may further include thermal spray coating at least a portion of the nitride layer to form a thermal spray layer, where the thermal spray coating includes at least one of a high velocity air fuel (HVAF) process or a high velocity oxygen fuel process (HVOF).

In another example embodiment of the present disclosure, a valve component may include a bulk material having a first surface and a second surface, a first portion of a nitride layer overlying the first surface, a second portion of the nitride layer overlying the second surface, and a thermal spray layer overlying the second portion of the nitride layer. The thermal spray layer may be harder than the bulk material and the nitride layer may be harder than the bulk material. The bulk material may have a substantially ferritic crystal structure.

In yet another example embodiment of the present disclosure, a plug valve may include a plurality of components, including at least a plug. The plug includes a bulk material of the plug, a first surface defining a bore extending radially through the plug, a second surface defining an outer circumference of the plug, a first layer disposed on the first surface of the plug, a second layer disposed on the second surface of the plug, and a third layer disposed over the second layer. The first layer may have a greater hardness than the bulk material and the second layer may have a greater hardness than the bulk material.

### BRIEF DESCRIPTION OF DRAWINGS

FIG. 1 is a schematic illustration of an example system of the present disclosure. In FIG. 1, the example system is represented as an example valve in the form of a plug valve, in accordance with example embodiments of the disclosure.

FIG. 2 is a schematic illustration of an exploded view of the plug valve as depicted in FIG. 1, according to example embodiments of the disclosure.

FIG. 3 is a schematic illustration of an example plug of the plug valve depicted in FIG. 1, according to example embodiments of the disclosure.

FIG. 4 is a schematic illustration of another example plug of the plug valve depicted in FIG. 1, according to example embodiments of the disclosure.

FIG. 5 is schematic illustration of example inserts of the plug valve depicted in FIG. 1, according to example embodiments of the disclosure.

FIG. 6 is schematic illustration of other example inserts of the plug valve depicted in FIG. 1, according to example embodiments of the disclosure.

FIG. 7 is a flow diagram depicting an example method for forming a valve component, according to example embodiments of the disclosure.

FIG. 8 is a flow diagram depicting another example method for forming a valve component, according to example embodiments of the disclosure.

### DETAILED DESCRIPTION

Wherever possible, the same reference numbers will be used throughout the drawings to refer to the same or like parts.

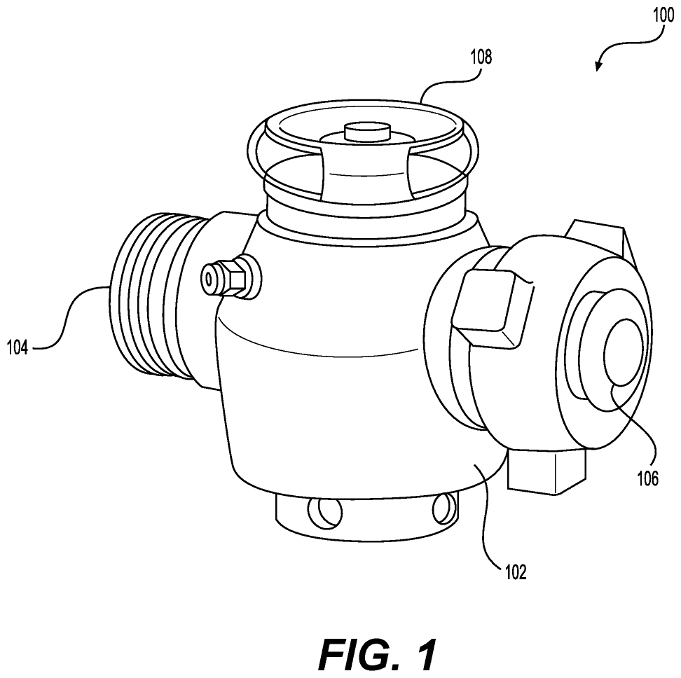

FIG. 1 is a schematic illustration of an example system of the present disclosure. As shown in FIG. 1, such an example system may include a valve in the form of a plug valve 100, in accordance with example embodiments of the disclosure. The plug valve 100 may include a housing 102 that retains one or more internal components of the plug valve 100 therein. The plug valve 100 may further include an inlet port 104 and an outlet port 106, and at least one of the inlet port 104 and the outlet port 106 may allow the flow of fluid through the plug valve 100. The plug valve 100 may still further include a handle 108 to allow an operator to turn on, turn off, and/or throttle the flow of fluid through the plug valve 100.

The housing 102 of the plug valve 100 may be constructed from any suitable material, such as alloy steel, aluminum, low carbon steel, mid carbon steel, high carbon steel, or the like. In example embodiments, the housing 102 may be constructed from alloy steel with carbon content less than 1% carbon by weight. In other example embodiments, the housing may be constructed from alloy steel with a carbon content in the range of about 0.25% to about 0.5% carbon by weight. Other elements present in the alloy steel may include, but is not limited to, chromium (Cr), cobalt (Co), molybdenum (Mo), nickel (Ni), titanium (Ti), tungsten (W), niobium (Nb), vanadium (V), combinations thereof, or the like. For example, the housing 102 may be formed from American Iron and Steel Institute (AISI) 4140 alloy steel, AISI 4141 alloy steel, or other similar alloy steel.

The inlet port 104 may define an orifice therethrough that allows the flow of fluid, such as hydraulic fracturing (fracking) slurry, into the plug valve 100. Similarly, the outlet port 106 may define an orifice therethrough that allows the flow of fluid out of the plug valve 100. Fluid may flow into the plug valve 100 through the inlet port 104 and out of the outlet port 106 when the handle 108 is positioned in a manner to allow the fluid flow through the plug valve 100. Similarly, fluid may be blocked from flowing into the plug valve 100 through the inlet port 104 and out of the outlet port 106 when the handle 108 is positioned in a manner to block the fluid flow through the plug valve 100. The handle 108 may be mechanically coupled to a plug housed within the housing 102 of the plug valve 100 that allows, blocks, and/or throttles the flow of fluid through the plug valve 100.

In applications such as fracking, the plug valve 100 may be used at a hydrocarbon well site to provide fluids at relatively high pressures. For example, the pressure of fracking slurry at the inlet port 104 of the plug valve may be at pressures exceeding 100 pounds per square inch (psi). In some cases, the pressure of the slurry may exceed 1000 psi. In still further embodiments, the slurry pressure may exceed 6000 psi. In yet other example embodiments, the slurry pressure may exceed 15,000 psi.

The slurry may be a mixture of various fluids with proppants, such as sand, alumina, silica, combinations thereof, or the like. Therefore, the slurry, with its constituent proppants and under extreme pressurization may result in high levels of wear on the plug valve 100 during use. To reduce the level of wear, the plug valve 100 may be lubricated, such as with relatively heavy grease, during use. The lubrication may be relatively frequent, such as every three to six times the plug valve 100 is used and/or toggled. Furthermore, even with frequent lubrication of the components of the plug valve 100, the components may wear down and require replacement on a regular basis. The embodiments of the disclosure, as discussed herein, improves the lifetime and/or wear of the components of the plug valve 100.

According to example embodiments of the disclosure, various components of valves, such as various components of the plug valve 100, may be formed in manner that improves their wear resistance. Additionally, in some cases, the various components of the plug valve 100 may also exhibit improved interactions with the slurry flowing through the plug valve 100 to allow reduced impediments to the flow of the slurry. The mechanisms as disclosed herein may apply to any variety of components of the plug valve 100.

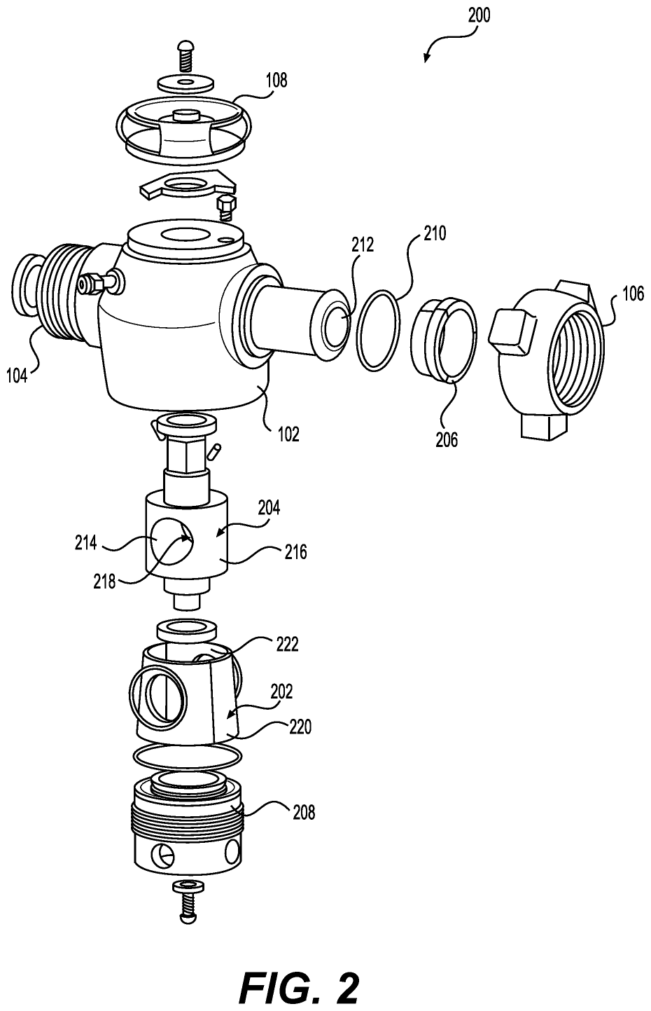

FIG. 2 is a schematic illustration of an exploded view 200 of the plug valve 100 as depicted in FIG. 1, according to example embodiments of the disclosure. As shown, the plug valve 100 may include inserts 202, a plug 204, and a base cap 208 to retain the inserts 202 and the plug 204 within the housing 102 of the plug valve 100. The plug valve may further include a gasket 210 and a retaining member 206 that may mate with an inner lip 212 of the outlet port 106.

The inserts 202 may be of any suitable number, such as two separate inserts 202. According to example embodiments, the inserts 202 may be shaped in a manner to mate with the plug 204 that may be seated within the inserts 202. For example, an outer surface 216 of the plug 204 may be seated within and/or in contact with an inner surface 222 of the inserts 202. The inserts 202 may define passages corresponding to the inlet port 104 and/or the outlet port 106 of the plug valve 100. Furthermore, the inserts 202 may be constructed from any suitable material, such as iron, cast iron, steel, alloy steel, low carbon steel, high carbon steel, aluminum, combinations thereof, or the like. In some cases, the inserts may be constructed from iron with a carbon content of greater than about 2.5% by weight and a silicon content of greater than about 2% by weight. The inserts 202 may be substantially ferritic and/or pearlitic in crystal structure. In example embodiments, the inserts 202 may be constructed from American Standard for Testing and Materials (ASTM) A536 cast iron, ASTM A370, or the like. In other example embodiments, the inserts may be constructed from alloy steel, high-carbon, medium-carbon, low-carbon steel, combinations thereof, or the like.

According to example embodiments of the disclosure an outer surface 220 of the inserts 202 may have a nitride layer thereon. Additionally, the inner surface 222 of the inserts may have a nitride layer and a thermal spray layer thereon. The nitride layer may be formed by a nitridation process and/or a ferritic nitrocarburizing process, while the thermal spray layer may be formed by a thermal spray process, such as a high velocity air fuel (HVAF) process, a high velocity oxygen fuel (HVOF) process, or the like. In example embodiments, the inner surface 222 of the inserts 202 may be treated with an overall thicker wear resistant coating (e.g., nitride layer and thermal spray layer) compared to the wear resistant coating (e.g., nitride layer) of the outer surface 220 of the inserts 202 due to additional wear on the inner surface 222 of the inserts 202 where there are tribological interactions between the plug 204 and the inserts 202.

In other example embodiments, the inserts 202 may include a nitride layer, such as ferritic nitrocarbide layer, on its outer surface 220, while the inner surface 222 includes a thermal spray coating and a nitrided thermal spray coating. For example, the thermal spray coating may include WC and the WC may be transformed to WN or a combination of WC and WN. This configuration of protective layers may be formed by performing a thermal spray coating of the inner surface 222 of the inserts 202, followed by a ferritic nitrocarburizing process of the entire surface (e.g., the inner surface 222 and the outer surface 220) of the inserts 202.

The plug 204, in example embodiments, may include an inner surface 214 and the outer surface 216. The inner surface may define a bore 218 of the plug 204 that allows the passage of fluids therethrough when the plug 204 is oriented in a manner that allows flow of fluid through the plug valve 100. The bore 218 may extend the diameter of the plug 204 and the orientation of the bore 218 relative to the inlet port 104 and the outlet port 106 may be controlled using the handle 108 to which the plug 204 may be mechanically coupled.

According to example embodiments, the inner surface 214 of the plug may include a nitride layer, such as a ferritic nitride layer and/or ferritic carbonitride layer. This protective layer may be harder and/or more wear resistant than the bulk material (e.g., AISI 4140 alloy steel, AISI 4141, etc.) of the plug 204 and provide wear resistance to the inner surface 214 of the plug 204. In some example embodiments, the protective layer may be a ferritic carbonitride layer that is formed by a salt bath carbonitriding process. In other cases, spherodized carbonitride layers and/or austenitic carbonitride layers may be formed. The outer surface 216 may include a nitride and/or carbonitride layer similar to the protective coating on the inner surface 214, as well as a thermal spray layer over the nitride/carbonitride layer. The thermal spray layer may be tungsten carbide (WC) in example embodiments. Alternatively, the thermal spray layer may include tungsten nitride (WN), diamond like carbon (DLC), tungsten (W), tantalum (Ta), titanium (Ti), chromium carbide (Cr₃C₂), vanadium carbide (VC, V₂C), alumina (Al₂O₃), alloy steel, ceramic materials, metals, combinations thereof, or the like.

In example embodiments, the outer surface 216 of the plug 204 may be treated with an overall thicker wear resistant coating (e.g., carbonitride layer and thermal spray layer) compared to the wear resistant coating (e.g., carbonitride layer) of the inner surface 214 of the plug 204 due to additional wear on the outer surface 216 of the plug 204 where there are tribological interactions between the plug 204 and the inserts 202. The nitride layer may be formed by a nitridation process and/or a ferritic nitrocarburizing process, while the thermal spray layer may be formed by a thermal spray process, such as HVAF processes, HVOF processes, or the like.

In other example embodiments, the plug 204 may include a nitride layer, such as ferritic nitrocarbide layer, on its inner surface 214, while the outer surface 216 includes a thermal spray coating and a nitrided thermal spray coating. For example, the thermal spray coating may include WC and an outer portion of the WC may be transformed to WN or a combination of WC and WN. This configuration of protective layers may be formed by performing a thermal spray coating of the outer surface 216 of the plug 204, followed by a ferritic nitrocarburizing process of the entire surface (e.g., the inner surface 214 and the outer surface 216) of the plug 204.

In other example embodiments, the plug 204 may include a nitride layer, such as ferritic nitrocarbide layer, on its inner surface 214, while the outer surface 216 includes a thermal spray coating and a nitrided thermal spray coating. For example, the thermal spray coating may include WC and an outer portion of the WC may be transformed to WN or a combination of WC and WN. This configuration of protective layers may be formed by performing a thermal spray coating of the inner surface of the plug 204, followed by a ferritic nitrocarburizing process of the entire surface (e.g., the inner surface 214 and the outer surface 216) of the plug 204.

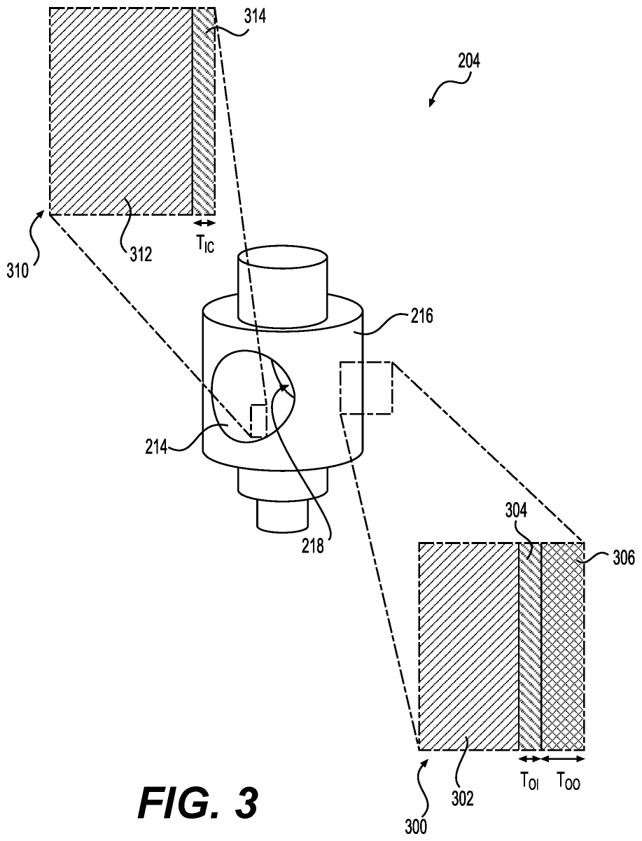

FIG. 3 is a schematic illustration of an example plug 204 of the plug valve 100 depicted in FIG. 1, according to example embodiments of the disclosure. As discussed herein, the inner surface 214 may include a surface portion 310 with a nitride layer and/or carbonitride layer 314 overlying bulk material 312 of the plug 204. Furthermore, the outer surface 216 may include a surface portion 300 with a nitride layer and/or carbonitride layer 304 overlying bulk material 302, with a thermal spray layer 306 overlying the nitride layer and/or carbonitride layer 304.

In example embodiments, the nitride layer and/or carbonitride layer 314 on the inner surface 214 may have a thickness (T_{IC}) in the range of about 10 microns (μm) to about 250 μm. In other example embodiments, the thickness (T_{IC}) may be in the range of about 25 μm to about 200 μm. In still other example embodiments, the thickness (T_{IC}) may be in the range of about 75 μm to about 175 μm. For example, the thickness (T_{IC}) of the nitride layer and/or carbonitride layer 314 may be approximately 150 μm. It should be understood that these ranges are examples and the thickness (T_{IC}) of the carbonitride layer 314 may be any suitable value.

In example embodiments, the nitride layer and/or carbonitride layer 304 on the outer surface 216 may have a thickness (T_{OI}) in the range of about 10 microns (μm) to about 250 μm. In other example embodiments, the thickness (T_{OI}) may be in the range of about 25 μm to about 200 μm. In still other example embodiments, the thickness (T_{OI}) may be in the range of about 75 μm to about 175 μm. For example, the thickness (T_{OI}) of the nitride layer and/or carbonitride layer 304 may be approximately 150 μm. In some cases, the thickness (T_{OI}) of the carbonitride layer 304 may be approximately the same as the thickness (T_{IC}) of the carbonitride layer 314. It should be understood that these ranges are examples and the thickness (T_{OI}) of the carbonitride layer 304 may be any suitable value.

In example embodiments, the thermal spray layer 306 on the outer surface 216 may have a thickness (T_{OO}) in the range of about 10 microns (μm) to about 200 μm. In other example embodiments, the thickness (T_{OO}) may be in the range of about 25 μm to about 175 μm. In still other example embodiments, the thickness (T_{OO}) may be in the range of about 50 μm to about 150 μm. For example, the thickness (T_{OO}) of the thermal spray layer 306 may be approximately 100 μm. In some cases, the thickness (T_{OO}) of the thermal spray layer 306 may be relatively thinner than the thickness (T_{IC}) of the carbonitride layer 304. It should be understood that these ranges are examples and the thickness (T_{OO}) of the thermal spray layer 306 may be any suitable value.

In example embodiments, the ratio thickness (T_{OI}) of the nitride layer and/or carbonitride layer 304 to the thickness (T_{OO}) of the thermal spray layer 306 (i.e., T_{OI}:T_{OO}) may be in the range of about 2.5 to about 0.4. In other example embodiments, the ratio of T_{OI}:T_{OO} may be in the range of about 2 to about 0.5. In still other example embodiments, the ratio of T_{OI}:T_{OO} may be in the range of about 1.75 to about 0.75. For example, the ratio of T_{OI}:T_{OO} may be approximately 1.5, when the thickness T_{IO} is 150 μm and the thickness T_{OO} is 100 μm. It should be understood that these ranges are examples and the ratio of T_{OI}:T_{OO} may be any suitable value.

In example embodiments, the thermal spray layer 306 may be formed by any suitable process, such as an HVOF process. In other example embodiments, other processes may be used to form the thermal spray layer 306, such as HVOF, HVAF, plasma spray, combinations thereof, or the like. Alternatively, the thermal spray layer may be WN, DLC, W, Ta, Ti, Cr₃C₂, vanadium carbide, alumina, alloy steel, ceramic materials, metals, combinations thereof, or the like.

In some example embodiments, the nitride layer and/or carbonitride layer 304, 314 may be formed by any suitable process, such as a ferritic nitrocarburizing process. The ferritic nitrocarburizing process may be performed at a temperature low enough to provide case hardening nitridation for alloy steel and/or iron compounds in a ferritic crystal state. The ferritic nitrocarburizing process may, in example embodiments, entail a quench-polish-quench (QPQ) process, with a nitrogen-rich molten salt bath and/or any number of pre-heat, quench, surface polish, and/or oxidation processes. For example, a MELONITE process, TENNIFER process, TUFFTRIDE process, SURSULF process, TEMOPLUS process, NU-TRIDE process, KOLENE process, combinations thereof, or the like. Other nitrocarburizing processes that use gas phase, plasma, and/or fluidized bed nitrogen sources may be used, such as vacuum nitrocarburizing, plasma nitrocarburizing, or the like may be used to form the nitride layer and/or carbonitride layer 304, 314. In other example embodiments, other types of case hardening may be performed to form the nitride layer and/or carbonitride layer 304, 314, such as other types of nitridation and/or surface oxidation.

It should also be noted that while the interfaces between the various layers, such as the bulk material 312 to the carbonitride layer 314, bulk material 302 to the carbonitride layer 304, and the thermal spray layer 306 to the carbonitride layer 304, are depicted as sharp boundaries, the boundaries may have any suitable gradation. For example, the boundaries between various layers 302, 304, 306, 312, 314 may be linearly graded and/or exponentially graded over a transition region between the various layers 302, 304, 306, 312, 314. Additionally, in some cases, there may be stoichiometric variation through the depth of one or more of the layers 302, 304, 306, 312, 314.

In some example embodiments, the nitride layer and/or carbonitride layer 304, 314 may have hardness in the range of about 40 Rockwell Hardness Scale C (HRC) to about 60 HRC. In other example embodiments, the hardness of the nitride layer and/or carbonitride layer 304, 314 may be in the range of about 50 to about 55 HRC. In some example embodiments, the thermal spray layer 306 may have a hardness in the range of about 62 HRC to about 75 HRC. In other example embodiments, the thermal spray layer 306 may have a hardness in the range of about 66 HRC to about 72 HRC. The underlying bulk material 302, 312, in comparison to the protective coatings, may be relatively softer. For example, the bulk material 302, 312 may have a hardness of 55 HRC or less. In other examples, the bulk material 302, 312 may have a hardness of 50 HRC or less.

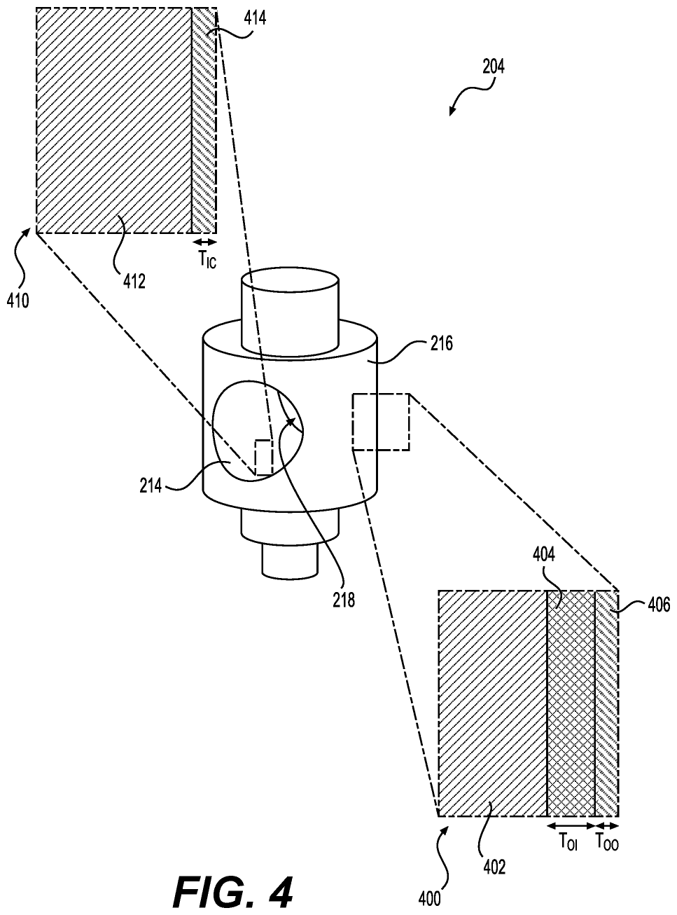

FIG. 4 is a schematic illustration of another example plug 204 of the plug valve 100 depicted in FIG. 1, according to example embodiments of the disclosure. As discussed herein, the inner surface 214 may include a surface portion 410 with a nitride layer and/or carbonitride layer 414 overlying bulk material 412 of the plug 204. Furthermore, the outer surface 216 may include a surface portion 400 with a thermal spray layer 404 overlying bulk material 402, with a nitride layer and/or carbonitride layer 406 overlying the thermal spray layer 404.

In example embodiments, physical attributes (e.g., thickness, composition, etc.) of the nitride layer and/or carbonitride layer 414 on the inner surface 214 may be substantially similar to the nitride layer and/or carbonitride layer 314, as described in conjunction with FIG. 3 above, and in the interest of brevity the description of the same is not repeated here. The nitride layer and/or carbonitride layer 414 may be formed, in example embodiments, concurrently with the formation of the nitride layer and/or carbonitride layer 406 that overlies the thermal spray layer 404.

In example embodiments, the thermal spray layer 404 may be formed by any suitable process, such as an HVAF process on the bulk material 402. In other example embodiments, other processes may be used to form the thermal spray layer 404, such as HVOF, plasma spray, combinations thereof, or the like. Alternatively, the thermal spray layer may be WN, DLC, W, Ta, Ti, Cr₃C₂, vanadium carbide, alumina, alloy steel, ceramic materials, metals, combinations thereof, or the like.

The nitride layer and/or carbonitride layer 406 may be formed by nitriding a portion of the thermal spray layer 404. The nitride layer and/or carbonitride layer 406 may be tungsten nitride (WN), tungsten carbonitride (WCₓN₁₋ₓ), tantalum nitride (TaN), titanium nitride (TiN), other metallic nitrides, other ceramic nitrides, combinations thereof, or the like. The nitride layer and/or carbonitride layer 406 may be formed concurrently with the nitride layer and/or carbonitride layer 414 on the inner surface 214. The inner surface 214, in these embodiments, may not be coated with the thermal spray layer 404. As a result, the nitride layer and/or carbonitride layer 414 on the inner surface 214 may be substantially similar to the nitride and/or carbonitride layer 314 of FIG. 3, while the nitride layer and/or carbonitride layer 406 on the outer surface 216 may be different from the nitride layer and/or carbonitride layer 414 on the inner surface 214 of the plug 204.

In example embodiments, the thermal spray layer 404 on the outer surface 216 may have a thickness (T_{OI}) in the range of about 10 μm to about 200 μm. In other example embodiments, the thickness (T_{OI}) may be in the range of about 25 μm to about 175 μm. In still other example embodiments, the thickness (T_{OI}) may be in the range of about 50 μm to about 150 μm. For example, the thickness (T_{OI}) of the thermal spray layer 404 may be approximately 100 μm. In some cases, the thickness (T_{OI}) of the thermal spray layer 404 may be relatively thicker than the thickness (T_{OO}) of the carbonitride layer 406. It should be understood that these ranges are examples and the thickness (T_{OI}) of the thermal spray layer 404 may be any suitable value.

In example embodiments, the nitride layer and/or carbonitride layer 406 on the outer surface 216 may have a thickness (T_{OO}) in the range of about 1 μm to about 100 μm. In other example embodiments, the thickness (T_{OO}) may be in the range of about 5 μm to about 75 μm. In still other example embodiments, the thickness (T_{OO}) may be in the range of about 10 μm to about 50 μm. For example, the thickness (T_{OO}) of the nitride layer and/or carbonitride layer 406 may be approximately 20 μm. In some cases, the thickness (T_{OO}) of the nitride layer and/or carbonitride layer 406 may be relatively thinner than the thickness (T_{OO}) of the thermal spray layer 406. It should be understood that these ranges are examples and the thickness (T_{OO}) of the thermal spray layer 404 may be any suitable value.

In some example embodiments, the nitride layer and/or carbonitride layer 406, 414 may be formed by any suitable process, such as a ferritic nitrocarburizing process. The ferritic nitrocarburizing process may be performed at a temperature low enough to provide case hardening nitridation for alloy steel and/or iron compounds in a ferritic crystal state. The ferritic nitrocarburizing process may, in example embodiments, entail a quench-polish-quench (QPQ) process, with a nitrogen-rich molten salt bath and/or any number of pre-heat, quench, surface polish, and/or oxidation processes. For example, a MELONITE process, TENNIFER process, TUFFTRIDE process, SURSULF process, TEMOPLUS process, NU-TRIDE process, KOLENE process, combinations thereof, or the like. Other nitrocarburizing processes that use gas phase, plasma, and/or fluidized bed nitrogen sources may be used, such as vacuum nitrocarburizing, plasma nitrocarburizing, or the like may be used to form the nitride layer and/or carbonitride layer 406, 414. In other example embodiments, other types of case hardening may be performed to form the nitride layer and/or carbonitride layer 406, 414, such as other types of nitridation and/or surface oxidation. It should further be understood that the nitride layer and/or carbonitride layer 406 may be formed by transforming a portion of the thermal spray layer 404.

It should also be noted that while the interfaces between the various layers, such as the bulk material 412 to the carbonitride layer 414, bulk material 402 to the thermal spray layer 406, and the thermal spray layer 404 to the carbonitride layer 406, are depicted as sharp boundaries, the boundaries may have any suitable gradation. For example, the boundaries between various layers 402, 404, 406, 412, 414 may be linearly graded and/or exponentially graded over a transition region between the various layers 402, 404, 406, 412, 414. Additionally, in some cases, there may be compositional and/or stoichiometric variation through the depth of one or more of the layers 402, 404, 406, 412, 414.

In some example embodiments, the nitride layer and/or carbonitride layer 414 may have hardness in the range of about 40 HRC to about 60 HRC. In other example embodiments, the hardness of the nitride layer and/or carbonitride layer 414 may be in the range of about 50 to about 55 HRC. In some example embodiments, the thermal spray layer 404 may have a hardness in the range of about 62 HRC to about 75 HRC. In other example embodiments, the thermal spray layer 404 may have a hardness in the range of about 66 HRC to about 72 HRC. In example embodiments, the nitride layer and/or carbonitride layer 406 may have a hardness in the range of about 60 HRC to about 75 HRC. In other example embodiments, the nitride layer and/or carbonitride layer 406 may have a hardness in the range of about 65 HRC to about 70 HRC. In some cases, the nitride layer and/or carbonitride layer 406 may be relatively softer than the thermal spray layer 404. The underlying bulk material 402, 412, in comparison to the protective coatings, may be relatively softer. For example, the bulk material 402, 412 may have a hardness of 55 HRC or less. In other examples, the bulk material 402, 412 may have a hardness of 50 HRC or less.

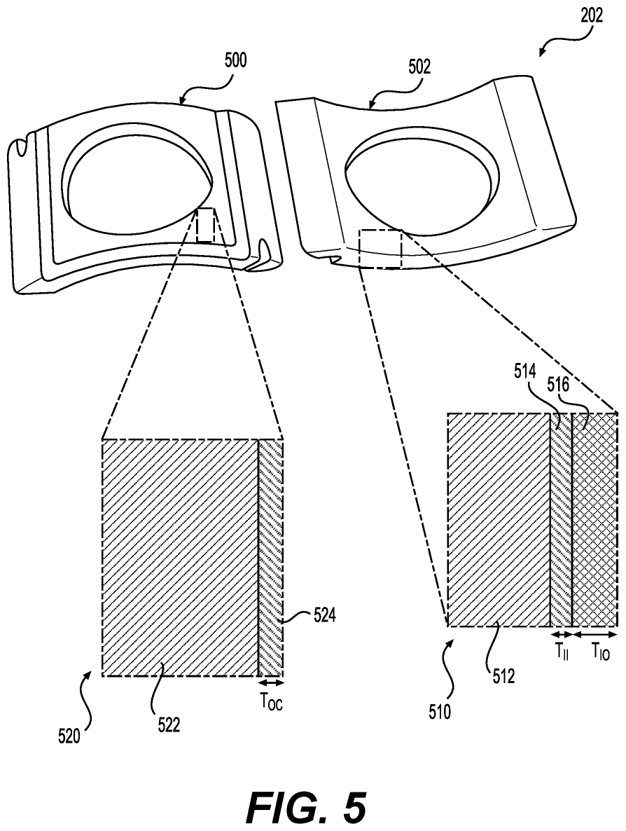

FIG. 5 is schematic illustration of example inserts 202 of the plug valve 100 depicted in FIG. 1, according to example embodiments of the disclosure. The inserts 202 may have an outer surface 500 and an inner surface 502. Both the outer surface 500 and the inner surface 502 of the inserts 202 may have protective, wear, and/or corrosion resistant layer(s) disposed thereon. In some cases, the protective layer(s) on the inner surface 502 may be thicker than the protective layer(s) on the outer surface 500 due to contact and/or tribological interaction between the inner surface 502 and the plug 204.

The inner surface 502 may include a surface portion 510 with a nitride layer and/or carbonitride layer 514 overlying bulk material 512 of the inserts 202, with thermal spray layer 516 overlying the nitride layer and/or carbonitride layer 514. Furthermore, the outer surface 500 may include a surface portion 520 with a nitride layer and/or carbonitride layer 524 overlying bulk material 522.

In example embodiments, the nitride layer and/or carbonitride layer 524 on the outer surface 500 may have a thickness (T_{OC}) in the range of about 10 μm to about 250 μm. In other example embodiments, the thickness (T_{OC}) may be in the range of about 25 μm to about 200 μm. In still other example embodiments, the thickness (T_{OC}) may be in the range of about 75 μm to about 175 μm. For example, the thickness (T_{OC}) of the nitride layer and/or carbonitride layer 314 may be approximately 150 μm. It should be understood that these ranges are examples and the thickness (T_{OC}) of the carbonitride layer 524 may be any suitable value.

In example embodiments, the nitride layer and/or carbonitride layer 514 on the inner surface 502 may have a thickness (T_{OI}) in the range of about 10 μm to about 250 μm. In other example embodiments, the thickness (T_{OI}) may be in the range of about 25 μm to about 200 μm. In still other example embodiments, the thickness (T_{II}) may be in the range of about 75 μm to about 175 μm. For example, the thickness (T_{II}) of the nitride layer and/or carbonitride layer 304 may be approximately 150 μm. In some cases, the thickness (T_{II}) of the carbonitride layer 514 may be approximately the same as the thickness (T_{OC}) of the carbonitride layer 524. It should be understood that these ranges are examples and the thickness (T_{II}) of the carbonitride layer 514 may be any suitable value.

In example embodiments, the thermal spray layer 516 on the inner surface 502 may have a thickness (T_{IO}) in the range of about 10 microns μm to about 200 μm. In other example embodiments, the thickness (T_{IO}) may be in the range of about 25 μm to about 175 μm. In still other example embodiments, the thickness (T_{IO}) may be in the range of about 50 μm to about 150 μm. For example, the thickness (T_{IO}) of the thermal spray layer 306 may be approximately 100 μm. In some cases, the thickness (T_{IO}) of the thermal spray layer 516 may be relatively thinner than the thickness (T_{II}) of the carbonitride layer 514. It should be understood that these ranges are examples and the thickness (T_{OO}) of the thermal spray layer 516 may be any suitable value.

In example embodiments, the ratio of the thickness (T_{II}) of the nitride layer and/or carbonitride layer 514 to the thickness of the thickness (T_{IO}) of the thermal spray layer 516 (i.e., T_{II}:T_{IO}) may be in the range of about 2.5 to about 0.4. In other example embodiments, the ratio of T_{II}:T_{IO} may be in the range of about 2 to about 0.5. In still other example embodiments, the ratio of T_{II}:T_{IO} may be in the range of about 1.75 to about 0.75. For example, the ratio of T_{II}:T_{IO} may be approximately 1.5, when the thickness T_{II} is 150 μm and the thickness T_{IO} is 100 μm. It should be understood that these ranges are examples and the ratio of T_{II}:T_{IO} may be any suitable value.

In example embodiments, the thermal spray layer 516 may be formed by any suitable process, such as an HVAF process. In other example embodiments, other processes may be used to form the thermal spray layer 306, such as HVOF, plasma spray, combinations thereof, or the like. Alternatively, the thermal spray layer 516 may have WN, DLC, W, Ta, Ti, Cr₃C₂, vanadium carbide, alumina, alloy steel, ceramic materials, metals, combinations thereof, or the like.

In some example embodiments, the nitride layer and/or carbonitride layer 514, 524 may be formed by any suitable process, such as a ferritic nitrocarburizing process. The ferritic nitrocarburizing process may be performed at a temperature low enough to provide case hardening nitridation for alloy steel and/or iron compounds in a ferritic crystal state. The ferritic nitrocarburizing process may, in example embodiments, entail a quench-polish-quench (QPQ) process, with a nitrogen-rich molten salt bath, and/or with any number of pre-heat, quench, surface polish, and/or oxidation processes. For example, a MELONITE process, TENNIFER process, TUFFTRIDE process, SURSULF process, TEMOPLUS process, NU-TRIDE process, KOLENE process, combinations thereof, or the like may be used. Other nitrocarburizing processes that use gas-phase, plasma, and/or fluidized-bed nitrogen sources may be used, such as vacuum nitrocarburizing, plasma nitrocarburizing, or the like, to form the nitride layer and/or carbonitride layer 514, 524. In other example embodiments, other types of case hardening may be performed to form the nitride layer and/or carbonitride layer 514, 524, such as other types of nitridation and/or surface oxidation.

It should also be noted that while the interfaces between the various layers, such as the bulk material 512 to the carbonitride layer 514, bulk material 522 to the carbonitride layer 524, and the thermal spray layer 516 to the carbonitride layer 514, are depicted as sharp boundaries, the boundaries may have any suitable gradation. For example, the boundaries between various layers 512, 514, 516, 522, 524 may be linearly graded and/or exponentially graded over a transition region between the various layers 512, 514, 516, 522, 524. Additionally, in some cases, there may be stoichiometric variation through the depth of one or more of the layers 512, 514, 516, 522, 524.

In some example embodiments, the nitride layer and/or carbonitride layer 514, 524 may have hardness in the range of about 40 Rockwell Hardness Scale C (HRC) to about 60 HRC. In other example embodiments, the hardness of the nitride layer and/or carbonitride layer 514, 524 may be in the range of about 50 to about 55 HRC. In some example embodiments, the thermal spray layer 516 may have a hardness in the range of about 62 HRC to about 75 HRC. In other example embodiments, the thermal spray layer 516 may have a hardness in the range of about 66 HRC to about 72 HRC. The underlying bulk material 512, 522, in comparison to the protective coatings, may be relatively softer. For example, the bulk material 512, 522 may have a hardness of 55 HRC or less. In other examples, the bulk material 512, 522 may have a hardness of 50 HRC or less.

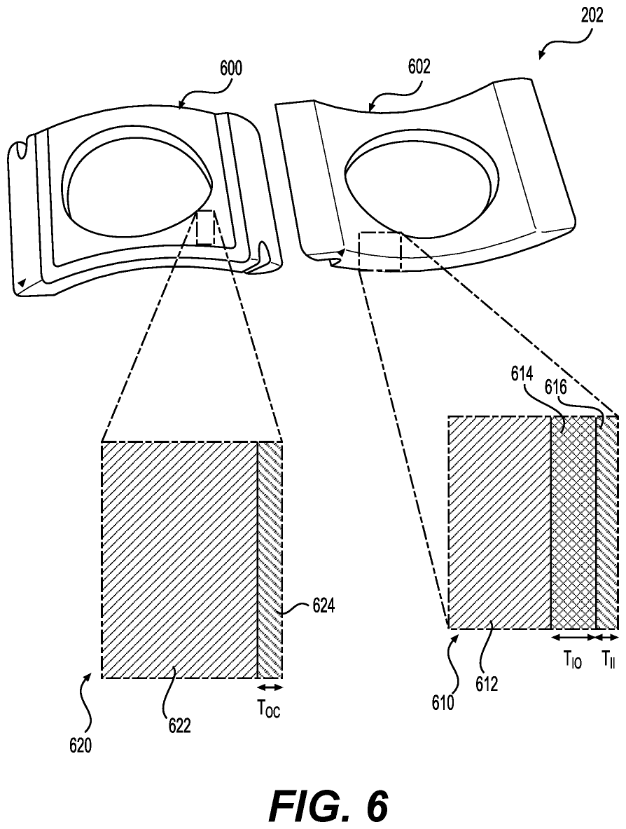

FIG. 6 is schematic illustration of other example inserts 202 of the plug valve 100 depicted in FIG. 1, according to example embodiments of the disclosure. The inserts 202 may have an outer surface 600 and an inner surface 602. Both the outer surface 600 and the inner surface 602 of the inserts 202 may have protective, wear and/or corrosion resistant layer(s) disposed thereon. In some cases, the protective layer(s) on the inner surface 602 may be thicker than the protective layer(s) on the outer surface 600 due to contact and/or tribological interaction between the inner surface 602 and the plug 204.

The inner surface 602 may include a surface portion 610 with a thermal spray layer 614 overlying bulk material 612 of the inserts 202, with a nitride layer and/or carbonitride layer 616 overlying the thermal spray layer 614. Furthermore, the outer surface 600 may include a surface portion 620 with a nitride layer and/or carbonitride layer 624 overlying bulk material 622.

In example embodiments, physical attributes (e.g., thickness, composition, etc.) of the nitride layer and/or carbonitride layer 624 on the outer surface 600 may be substantially similar to the nitride layer and/or carbonitride layer 524, as described in conjunction with FIG. 5 above, and in the interest of brevity the description of the same is not repeated here. The nitride layer and/or carbonitride layer 624 may be formed, in example embodiments, concurrently with the formation of the nitride layer and/or carbonitride layer 616 that overlies the thermal spray layer 614.

In example embodiments, the thermal spray layer 614 may be formed by any suitable process, such as an HVAF process on the bulk material 612. In other example embodiments, other processes may be used to form the thermal spray layer 614, such as HVOF, plasma spray, combinations thereof, or the like. In some example embodiments the thermal spray layer 614 may include WC. Alternatively, the thermal spray layer 614 include WN, DLC, W, Ta, Ti, Cr₃C₂, vanadium carbide, alumina, alloy steel, ceramic materials, metals, combinations thereof, or the like.

The nitride layer and/or carbonitride layer 616 may be formed by nitriding a portion of the thermal spray layer 614. The nitride layer and/or carbonitride layer 616 may include tungsten nitride (WN), tungsten carbonitride (WCₓN₁₋ₓ), tantalum nitride (TaN), titanium nitride (TiN), other metallic nitrides, other ceramic nitrides, combinations thereof, or the like. The nitride layer and/or carbonitride layer 616 may be formed concurrently with the nitride layer and/or carbonitride layer 624 on the outer surface 600. The outer surface 600, in these embodiments, may not be coated with the thermal spray layer 614. As a result, the nitride layer and/or carbonitride layer 624 on the outer surface 600 may be substantially similar to the nitride and/or carbonitride layer 524 of FIG. 5, while the nitride layer and/or carbonitride layer 616 on the inner surface 602 may be different from the nitride layer and/or carbonitride layer 624 on the outer surface 600 of the inserts 202.

In example embodiments, the thermal spray layer 614 on the inner surface 602 may have a thickness (T_{IO}) in the range of about 10 μm to about 200 μm. In other example embodiments, the thickness (T_{IO}) may be in the range of about 25 μm to about 175 μm. In still other example embodiments, the thickness (T_{IO}) may be in the range of about 50 μm to about 150 μm. For example, the thickness (T_{IO}) of the thermal spray layer 404 may be approximately 100 μm. In some cases, the thickness (T_{IO}) of the thermal spray layer 614 may be relatively thicker than the thickness (T_{II}) of the carbonitride layer 616. It should be understood that these ranges are examples and the thickness (T_{IO}) of the thermal spray layer 614 may be any suitable value.

In example embodiments, the nitride layer and/or carbonitride layer 616 on the inner surface 602 may have a thickness (T_{II}) in the range of about 1 μm to about 100 μm. In other example embodiments, the thickness (T_{II}) may be in the range of about 5 μm to about 75 μm. In still other example embodiments, the thickness (T_{II}) may be in the range of about 10 μm to about 50 μm. For example, the thickness (T_{II}) of the nitride layer and/or carbonitride layer 616 may be approximately 20 μm. In some cases, the thickness (T_{II}) of the nitride layer and/or carbonitride layer 616 may be relatively thinner than the thickness (T_{IO}) of the thermal spray layer 614. It should be understood that these ranges are examples and the thickness (T_{II}) of the nitride layer and/or carbonitride layer 616 may be any suitable value.

In some example embodiments, the nitride layer and/or carbonitride layer 624, 616 may be formed by any suitable process, such as a ferritic nitrocarburizing process. The ferritic nitrocarburizing process may be performed at a temperature low enough to provide case hardening nitridation for alloy steel and/or iron compounds in a ferritic crystal state. The ferritic nitrocarburizing process may, in example embodiments, entail a quench-polish-quench (QPQ) process, with a nitrogen-rich molten salt bath and/or any number of pre-heat, quench, surface polish, and/or oxidation processes. For example, a MELONITE process, TENNIFER process, TUFFTRIDE process, SURSULF process, TEMOPLUS process, NU-TRIDE process, KOLENE process, combinations thereof, or the like. Other nitrocarburizing processes that use gas phase, plasma, and/or fluidized bed nitrogen sources may be used, such as vacuum nitrocarburizing, plasma nitrocarburizing, or the like may be used to form the nitride layer and/or carbonitride layer 624, 616. In other example embodiments, other types of case hardening may be performed to form the nitride layer and/or carbonitride layer 624, 616, such as other types of nitridation and/or surface oxidation. It should further be understood that the nitride layer and/or carbonitride layer 616 may be formed by transforming a portion of the thermal spray layer 614.

It should also be noted that while the interfaces between the various layers, such as the bulk material 622 to the carbonitride layer 624, bulk material 612 to the thermal spray layer 614, and the thermal spray layer 614 to the carbonitride layer 616, are depicted as sharp boundaries, the boundaries may have any suitable gradation. For example, the boundaries between various layers 612, 614, 616, 622, 624 may be linearly graded and/or exponentially graded over a transition region between the various layers 612, 614, 616, 622, 624. Additionally, in some cases, there may be stoichiometric variation through the depth of one or more of the layers 612, 614, 616, 622, 624.

In some example embodiments, the nitride layer and/or carbonitride layer 624 may have hardness in the range of about 40 HRC to about 60 HRC. In other example embodiments, the hardness of the nitride layer and/or carbonitride layer 624 may be in the range of about 50 to about 55 HRC. In some example embodiments, the thermal spray layer 614 may have a hardness in the range of about 62 HRC to about 75 HRC. In other example embodiments, the thermal spray layer 614 may have a hardness in the range of about 66 HRC to about 72 HRC. In example embodiments, the nitride layer and/or carbonitride layer 616 may have a hardness in the range of about 60 HRC to about 75 HRC. In other example embodiments, the nitride layer and/or carbonitride layer 616 may have a hardness in the range of about 65 HRC to about 70 HRC. In some cases, the nitride layer and/or carbonitride layer 616 may be relatively softer than the thermal spray layer 614. The underlying bulk material 612, 622, in comparison to the protective coatings, may be relatively softer. For example, the bulk material 612, 622 may have a hardness of 55 HRC or less. In other examples, the bulk material 612, 622 may have a hardness of 50 HRC or less.

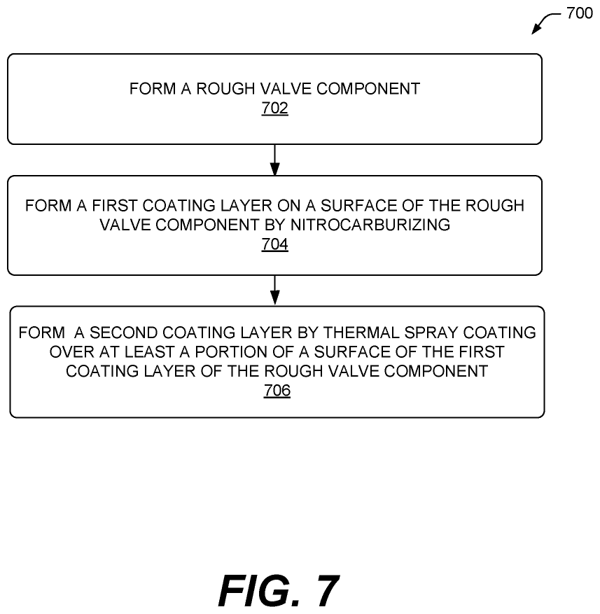

FIG. 7 is a flow diagram depicting an example method 700 for forming a valve component, according to example embodiments of the disclosure. The method 700 may be used to form any suitable type of valve component, such as the plug 204 and/or the inserts 202. In other example embodiments, other components of the plug valve 100 may be formed, such as an inlet port 104, an outlet port 106, or the like. In example embodiments, the method 700 may be used to form the plug 204, as described in conjunction with FIG. 3, and/or the inserts 202, as described in conjunction with FIG. 5.

At block 702, a rough valve component may be formed. The rough valve component may be any suitable component, such as the plug 204, the inserts 202, or the like. The rough valve component may be fabricated from any suitable material, such as alloy steel, low-carbon steel, medium-carbon steel, high-carbon steel, iron, or any other ferrous or non-ferrous material. Example materials for forming the rough components may include AISI 4140 alloy steel, AISI 4141 alloy steel, or other similar alloy steel, A536 cast iron, ASTM A370, or other similar iron alloys. In some cases, the material of construct of the rough valve component may be substantially in a ferritic structure. This form of the steel or iron is relatively soft and ductile and is, therefore, amenable to machining and may provide for a high level of toughness of the finished valve component. Formation of the rough valve component, such as in the form of the plug 204 and/or inserts 202, may include any variety of machining techniques suitable for forming the rough valve component. For example, any type of shaping, turning, milling, drilling, grinding, and/or other machining techniques may be used to form the rough valve component.

At block 704, a first coating layer may be formed on a surface of the rough valve component by nitrocarburizing. In example embodiments, this process may form nitride layer and/or carbonitride layer 304, 314, 514, 524, as described in conjunction with FIGS. 3 and 5. The nitrocarburizing process may be a case hardening process by which a depth into the surface of the rough component may be hardened by nitridation and/or carbonitridation. In example embodiments, the nitride layer and/or carbonitride layers 304, 314, 514, 524 over the uncoated surface of the rough valve component may include a ferrous nitride (FeₓN) layer and/or a ferrous carbonitride (FeₓC_{y}N_{z}) layer.

The nitrocarburizing process may, in example embodiments, include a nitriding and/or carbonitriding molten salt bath, where the rough component is submerged in a molten salt bath containing nitrogen and/or carbon at conditions that allow diffusion of the nitrogen and/or carbon into the ferrous metals at the surface of the rough component. This type of salt-bath ferritic nitrocarburizing may be performed with any suitable nitrogen containing salts, such as alkali cyanate, or similar salts. In example embodiments, the salt-bath ferritic nitrocarburizing process may be conducted at a temperature in the range of about 525° C. to about 625° C. For example, the salt bath nitrocarburization may be conducted at 565° C. In example embodiments, the ferritic nitrocarburizing process may be performed at a temperature low enough to provide case hardening nitridation for alloy steel and/or iron compounds in a ferritic crystal state. In example embodiments, the salt bath ferritic nitrocarburizing process may be conducted for a time in the range of about 15 minutes to about 5 hours. In other example embodiments, the salt-bath ferritic nitrocarburizing process may be conducted for a time in the range of about 30 minutes to about 3 hours. In still other example embodiments, the salt bath ferritic nitrocarburizing process may be conducted for a time in the range of about 1 hour to about 2 hours. For example, the salt bath ferritic nitrocarburizing process may be conducted for approximately 90 minutes.

In some example embodiments, the first coating layer may be formed by any suitable implementation of a ferritic nitrocarburizing process with salt bath ferritic nitrocarburization. The ferritic nitrocarburizing process may, in example embodiments, entail a multistep quench-polish-quench (QPQ) process, with a nitrogen-rich molten salt-bath and/or any number of pre-heat, quench, surface polish, oxidation processes, and/or sulfurization. For example, a MELONITE process, TENNIFER process, TUFFTRIDE process, SURSULF process, TEMOPLUS process, NU-TRIDE process, KOLENE process, combinations thereof, or the like. These types of processes may be relatively low-heat processes and/or relatively low distortion processes compared to other types of case hardening mechanisms.

For example, in one example ferritic nitrocarburizing process, the rough component may be preheated, such as in a preheat furnace. After preheating, the rough component may be immersed in a molten, aerated solution having nitrogen and/or carbon containing salts. This molten salt-bath process may be conducted according to the temperature and/or time ranges discussed above. The rough component, after nitriding, may be oxidized, such as in an oxidizing bath (e.g., oxidizing salt bath). In some cases, this may form a surface layer of magnetite (Fe₃O₄). The rough component may then be quenched, such as in a water bath, oil bath, air, or any other suitable environment. After quenching, the rough component may be polished by any suitable process, such as vibratory polishing, lapping, glass bead blasting, combinations thereof, or the like. Next, the rough component immersed in an oxidizing bath and quenched again. It should be understood that this is one example sequence of processes to perform the nitrocarburizing process, and there may be any number of suitable processes before or after the ferritic nitrocarburizing salt bath.

In other example embodiments, other nitrocarburizing processes that use gas phase, plasma, and/or fluidized bed nitrogen sources may be used, such as vacuum nitrocarburizing, plasma nitrocarburizing, or the like may be used to form the first coating layer. In still other example embodiments, other types of case hardening may be performed to form the first coating layer, such as other types of nitridation and/or surface oxidation.

At block 706, a second coating layer may be formed by thermal spray coating over at least a portion of a surface of the first coating layer of the rough valve component. For example, with the plug 204, the second coating layer may embody the thermal spray layer 306 applied over the nitride layer and/or carbonitride layer 304, but not over the nitride layer and/or carbonitride layer 314, as described in conjunction with FIG. 3. Similarly, with the inserts 202, the second coating layer may embody the thermal spray layer 516 applied over the nitride layer and/or carbonitride layer 514, but not over the nitride layer and/or carbonitride layer 524, as described in conjunction with FIG. 5. In alternate example embodiments, the second coating layer may be applied over the entirety of the first coating layer.

In example embodiments, the second coating layer may be formed by any suitable thermal spray process, such as a high velocity air fuel (HVAF) process. The HVAF process, in example embodiments, may result in minimal increase on the surface temperature of the rough component, leading to relatively reduced levels of distortion and/or warping compared to other coating processes. The HVAF process may also allow relatively high coating speed, as well as high surface adhesion. In example embodiments, the HVAF process may entail ejecting coating powders, along with air and fuel through a nozzle. The fuel, such as pressurized propane, propylene, natural gas, or the like, along with pressurized air may carry the coating powder in its stream, as this mixture is provided through the nozzle. For example, the coating powder may be WC powder for depositing WC as the second coating layer. The second coating layer may be deposited on the rough valve component by rastering the nozzle over the surface of the rough valve component or rastering the rough valve component under the nozzle.

In other example embodiments, other processes may be used to form the second coating layer, such as HVOF, plasma spray, combinations thereof, or the like. In some example embodiments the second coating layer may include materials other than WC. For example, the second coating layer may include WN, DLC, W, Ta, Ti, Cr₃C₂, vanadium carbide, alumina, alloy steel, ceramic materials, metals, combinations thereof, or the like.

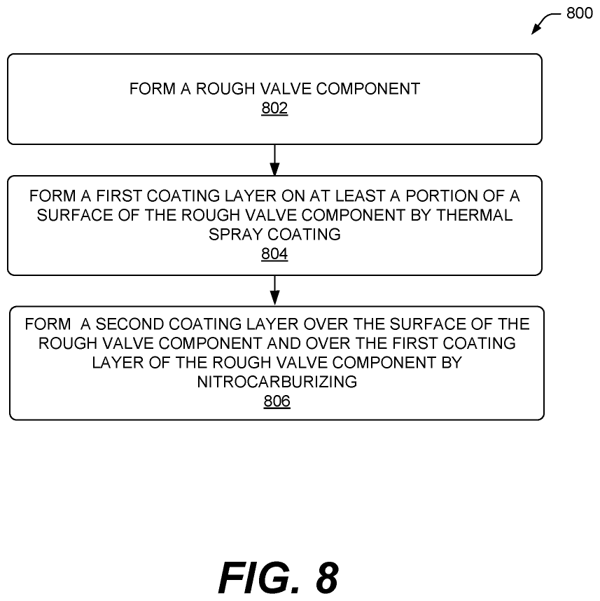

FIG. 8 is a flow diagram depicting another example method 800 for forming a valve component, according to example embodiments of the disclosure. The method 800 may be used to form any suitable type of valve component, such as the plug 204 and/or the inserts 202. In other example embodiments, other components of the plug valve 100 may be formed, such as an inlet port 104, an outlet port 106, or the like. In example embodiments, the method 800 may be used to form the plug 204, as described in conjunction with FIG. 4, and/or the inserts 202, as described in conjunction with FIG. 6.

At block 802, a rough valve component may be formed. The rough valve component may be any suitable component, such as the plug 204, the inserts 202, or the like. The rough valve component may be fabricated from any suitable material, such as alloy steel, low-carbon steel, medium-carbon steel, high-carbon steel, iron, or any other ferrous or non-ferrous material. Example materials for forming the rough components may include AISI 4140 alloy steel, AISI 4141 alloy steel, or other similar alloy steel, A536 cast iron, ASTM A370, or other similar iron alloys. In some cases, the material of construct of the rough valve component may be substantially in a ferritic structure. This form of the steel or iron is relatively soft and ductile and is, therefore, amenable to machining and may provide for a high level of toughness of the finished valve component. Formation of the valve component, such as the plug 204 and/or inserts 202, may include any variety of machining techniques suitable for forming the valve component. For example, any type of shaping, turning, milling, drilling, grinding, and/or other machining techniques may be used to form the rough valve component.

At block 804, a first coating layer may be formed on at least a portion of a surface of the rough valve component by thermal spray coating. For example, with the plug 204, the first coating layer may embody the thermal spray layer 404 applied over the outer surface 216, while no thermal spray layer is provided on the inner surface 214, as described in conjunction with FIG. 4. Similarly, with the inserts 202, the first coating layer may embody the thermal spray layer 614 applied over the inner surface 602, while no thermal spray layer is provided on the outer surface 600, as described in conjunction with FIG. 6. In alternate example embodiments, the first coating layer may be applied over the entirety of the first coating layer. The process for deposition the first coating layer by the process of block 804 may be substantially similar to the process for depositing the second coating layer of block 706 of method 700 of FIG. 7, and in the interest of brevity, will not be repeated here.

At block 806, a second coating layer may be formed over the surface of the rough valve component and over the first coating layer of the rough valve component by nitrocarburizing. The nitrocarburizing process for deposition the second coating layer by the process of block 806 may be substantially similar to the process for depositing the first coating layer of block 704 of method 700 of FIG. 7, and in the interest of brevity, will not be repeated here. However, the second coating layer may be compositionally different in the portions overlying the uncoated surface of the rough valve component than the portions overlying the first coating layer. In other words, the nitride layer and/or carbonitride layer 414 may be compositionally different from the nitride layer and/or carbonitride layer 406 of the plug 204, as shown in FIG. 4, even though both the nitride layer and/or carbonitride layer 414 and nitride layer and/or carbonitride layer 406 are formed concurrently by the nitrocarburizing process. Similarly, the nitride layer and/or carbonitride layer 624 may be compositionally different from the nitride layer and/or carbonitride layer 616 of the inserts 202, as shown in FIG. 6, even though both the nitride layer and/or carbonitride layer 624 and nitride layer and/or carbonitride layer 616 are formed concurrently by the nitrocarburizing process.

In example embodiments, the nitride layer and/or carbonitride layers 414, 624 over the uncoated surface of the rough valve component may include a ferrous nitride (FeₓN) layer and/or a ferrous carbonitride (FeₓC_{y}N_{z}) layer, while the nitride layer and/or carbonitride layers 406, 616 may include nitrides and/or carbonitrides of the thermal spray layers 404, 614. In example embodiments, these nitride layer and/or carbonitride layers 406, 616 may include tungsten nitride and/or tungsten carbonitride.

### INDUSTRIAL APPLICABILITY

The present disclosure describes systems, apparatus, and methods associated with wear tolerant, corrosion tolerant, and/or tough components, such as components for plug valves 100. These improved components may include plugs 204 used to control the flow of fluids through the plug valve 100, as well as inserts 202 with which the plugs 204 make contact during the operation of the plug valve 100. In addition to improved wear resistance, the valve components may have additional benefits, such as reduced surface friction.

The plug 204, as disclosed herein, may have an inner surface 214 that may include a ferritic nitride and/or ferritic carbonitride layer. The plug 204 may further have an outer surface 216 that is a ferritic nitride and/or ferritic carbonitride layer and an overlying thermal spray coating layer. In example embodiments, this double protective layer of the outer surface 216 may be a ferritic carbonitride layer with a tungsten carbide (WC) layer thereon. In another example embodiment, the double protective layer of the outer surface 216 may include a WC layer with a relatively thinner WN layer thereon. Additionally, some portions of the plug 204 may have two or more protective layers, while other portions may only have a single protective layer. By forming the plugs 204 by applying thicker protective layer(s) selectively to the plug 204, the cost of manufacture of the plug valve 100 may be controlled, while providing a greater value in service lifetime and maintenance downtime.

Similar to the plug 204, the plug valve 100 may include inserts 202 that may also include one or more protective layer(s). A thicker protective zone may be formed where greater levels of wear protection is needed, without providing a thick protective zone over the entirety of the surface, thereby reducing the cost of manufacture. In one example embodiment, the inserts 202 may also include a single protective layer on their outside surface, while the inside surface may include two or more protective layers. Similar to the case of the plugs 204, the protective layer(s) provided on the inserts may increase the usable lifetime of the inserts 202 and/or reduce the frequency of maintenance, such as greasing the parts of the plug valve 100. Reduced maintenance, such as greasing of the plug valve 100 components, may reduce the period of downtime in the field, such as in a fracking operation, resulting in greater production and/or throughput from a fracking well.

Although the processes of forming protective coatings are discussed in the context of valves and valve components, it should be appreciated that the mechanisms discussed herein may be applied to a wide array of mechanical parts in a wide variety of systems used in any variety of industries. For example the protective coatings discussed herein may be applied to industrial fabrication equipment, like metal working equipment, construction equipment, or automotive parts.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein.

What is claimed is:

1. A method for manufacturing a valve component, comprising:
ferritic nitrocarburizing a rough valve component to form a nitride layer over a surface of the valve component, the ferritic nitrocarburizing including a molten salt bath nitridation, wherein the rough valve component is formed from ferrous material having a substantially ferritic crystal structure; and
thermal spray coating at least a portion of the nitride layer to form a thermal spray layer, the thermal spray coating including at least one of a high velocity air fuel (HVAF) process or a high velocity oxygen fuel process (HVOF).

2. The method of claim 1, wherein the rough valve component comprises a plug having an inner surface defining a bore hole radially though the plug and an outer surface, wherein the ferritic nitrocarburizing is performed on the inner surface and the outer surface, and wherein thermal spray coating is performed on the outer surface.

3. The method of claim 2, wherein the plug comprises low-carbon alloy steel.

4. The method of claim 1, wherein the valve component comprises an insert having an inner surface and an outer surface opposing the inner surface, wherein the ferritic nitrocarburizing is performed on the inner surface and on the outer surface, and wherein thermal spray coating is performed on the inner surface.

5. The method of claim 4, wherein the insert comprises cast iron.

6. The method of claim 1, wherein the thermal spray coating includes powder tungsten carbide.

7. The method of claim 1, wherein the thermal spray layer is at least 75 μm in thickness.

8. The method of claim 1, wherein ferritic nitrocarburizing the rough valve component further comprises performing an oxidation process on the rough valve component and performing a quench process on the rough valve component.

9. The method of claim 1, wherein ferritic nitrocarburizing the rough valve component further comprises performing a polishing process on the rough valve component.

10. A valve component, comprising:
a bulk material having a first surface and a second surface;
a first portion of a nitride layer overlying the first surface;
a second portion of the nitride layer overlying the second surface; and
a thermal spray layer overlying the second portion of the nitride layer, wherein:
the thermal spray layer is harder than the bulk material,
the nitride layer is harder than the bulk material, and
the bulk material has a substantially ferritic crystal structure.

11. The valve component of claim 10, wherein:
the bulk material has a hardness of less than 50 HRC; and
the nitride layer has a hardness of at least 60 HRC.

12. The valve component of claim 10, wherein the valve component comprises a plug, the first surface defines a bore hole radially though the plug, and the thermal spray layer is formed by performing a thermal spray coating on the second portion of the nitride layer.

13. The valve component of claim 12, wherein the bulk material is at least one of American Iron and Steel Institute (AISI) 4140 alloy steel or AISI 4141 alloy steel.

14. The valve component of claim 10, wherein the valve component comprises an insert, the first surface comprises an outer surface of the insert, the second surface comprises an inner surface opposing the outer surface, and, during use, the inner surface is in contact with a plug.

15. The valve component of claim 10, wherein the first portion of the nitride layer is at least 100 μm in thickness.

16. A plug valve comprising a plurality of components including at least a plug, wherein the plug comprises:
a bulk material of the plug;
a first surface defining a bore extending radially through the plug;
a second surface defining an outer circumference of the plug;
a first layer disposed on the first surface of the plug;
a second layer disposed on the second surface of the plug; and
a third layer disposed over the second layer,
wherein the first layer has a greater hardness than the bulk material and the second layer has a greater hardness than the bulk material.

17. The plug valve of claim 16, wherein the third layer is formed by ferritic nitrocarburizing the second layer, and wherein the first layer is formed by nitrocarburizing the bulk material.

18. The plug valve of claim 16, wherein the bulk material comprises ferritic crystal structure.

19. The plug valve of claim 16, wherein the first layer comprises a ferrous nitride layer, the second layer comprises a tungsten carbide layer, and the third layer comprises a tungsten nitride layer.

20. The plug valve of claim 16, wherein the second layer is at least 100 μm in thickness.
